(19) United States
(12) Patent Application Publication
(10) Pub. No.: US 2011/0077951 A1
(43) Pub. Date: Mar. 31, 2011

(54) Mobile Device Including Mobile Application

(76) Inventor: John Tullis, San Francisco, CA (US)

(21) Appl. No.: 12/833,846

(22) Filed: Jul. 9, 2010

Related U.S. Application Data
(60) Provisional application No. 61/247,442, filed on Sep. 30, 2009.

(51) Int. Cl. G06Q 30/00

(52) U.S. Cl. 705/1.1

(57) ABSTRACT

Consumers' purchase transactions are collected and processed to produce purchase transaction history information indicative of purchasing behavior and spending patterns. Computer software applications are identified based on the purchase history information and sent to the consumer's mobile devices.

### CROSS-REFERENCES TO RELATED APPLICATIONS

This application claims priority to U.S. Provisional Application No. 61/247,442, filed Sep. 30, 2009 and is fully incorporated herein by reference for all purposes. This application is related to a concurrently filed U.S. application, identified by attorney docket number 016222-055920US, entitled “MOBILE DEVICE INCLUDING MOBILE APPLICATION COORDINATING EXTERNAL DATA,” and is fully incorporated herein by reference for all purposes.

### BACKGROUND

A payment processing system (payment processors, payment processing network) facilitates the transactions between a merchant and consumers wanting to purchase goods or services from the merchant using a portable payment device such as a credit card or a debit card. Conventionally known payment processors include Visa, MasterCard, Discover, and the like. Portable payment devices (e.g., credit cards, mobile payment devices) are typically issued to consumers by an issuer (typically a financial institution such as a bank). The payment processing system mediates a communication (generally referred to as “authorization”) between the merchant's bank (acquirer) and the issuer (a financial institution that issues the portable payment device) when the consumer desires to make a purchase. The authorization is the conventional mechanism by which the issuer confirms to the merchant that the consumer has sufficient funds in an account with the issuer to make the purchase.

The purchase transaction that was initiated by the consumer generates information that is stored by the payment processor relating to specifics of the transaction, including time and place, identification of the goods, and so on. Over time, the payment processor can accumulate a history of transaction data regarding purchase habits of the consumer.

### BRIEF SUMMARY

In accordance with embodiments of the present invention, information can be collected by the payment processing system about a consumer's purchase history and purchase behavior. In embodiments, the purchase history and purchase behavior can be based on purchase transaction information related to the consumer's purchases. In embodiments, mobile device applications can be provided to the consumer's mobile device based at least on the consumers' purchase history and purchase behavior.

In accordance with embodiments of the present invention, mobile device applications can be associated with keywords, concepts, targeting criteria (collectively referred to herein as “tags”), and any other such matching information. The matching information can be used in conjunction with the consumers' purchase history and purchase behavior to identify candidate applications for delivery to the consumer.

These and other embodiments of the present invention are disclosed below in connection with drawings provided with this application.

### BRIEF DESCRIPTION OF THE DRAWINGS

FIGS. 1 and 1A-1C illustrate embodiments of a system in accordance with the present invention.

FIGS. 2 and 2A illustrate embodiments of flow processing relating to the accumulation of purchase transaction history in accordance with the present invention.

FIG. 3 shows typical data that may be collected for consumers in accordance with the present invention.

FIG. 4 illustrates an embodiment of flow processing for a computer software application in accordance with the present invention.

FIG. 5 illustrates additional details of the processing in FIG. 4.

FIG. 6 illustrates a computer system that can be used to implement computer system embodiments of the present invention.

### DETAILED DESCRIPTION

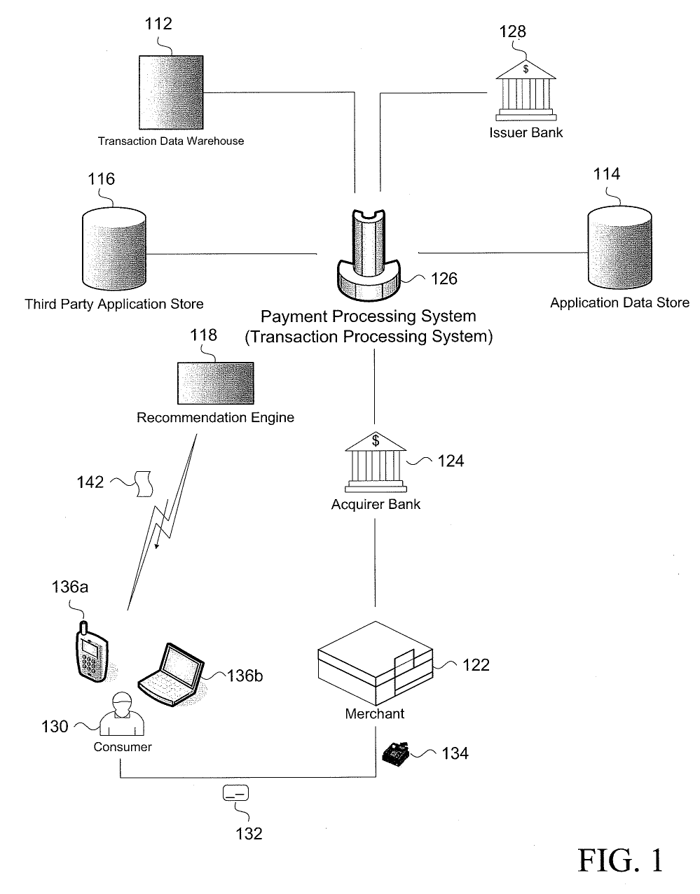

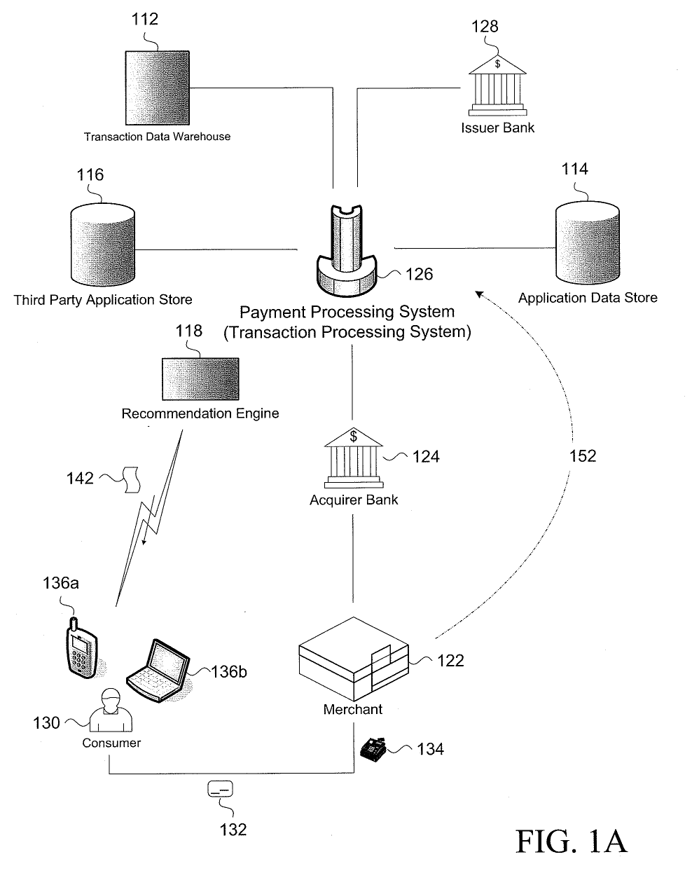

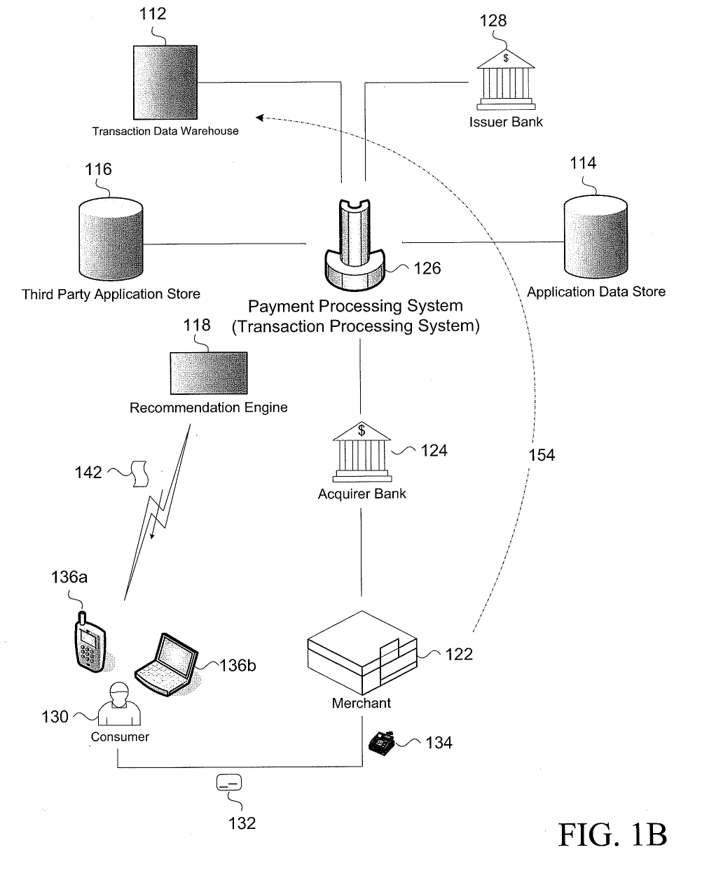

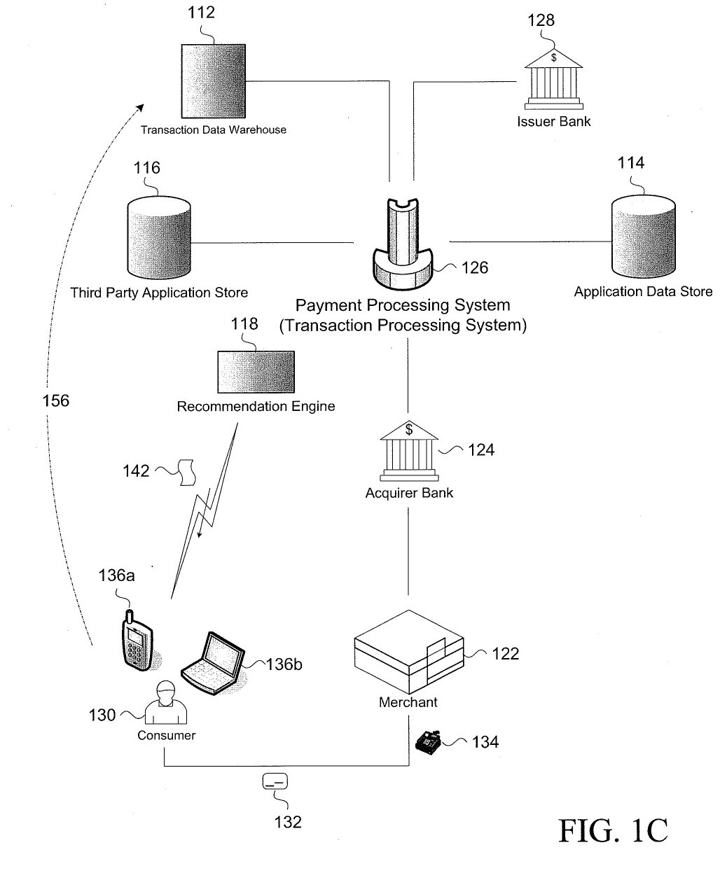

FIG. 1 shows an embodiment of a system in accordance with the present invention. There is a merchant 122 and an acquirer 124 associated with the merchant 122. The acquirer 124 can communicate with an issuer 128 via a payment processing system 126. In a typical purchase transaction, a consumer 130 may purchase goods or services at the merchant 122 using a portable consumer device 132. The consumer 130 may be an individual, or an organization such as a business that is capable of purchasing goods or services.

The portable consumer device 132 may be in any suitable form. For example, suitable portable consumer devices can be hand-held and compact so that they can fit into a consumer's wallet or pocket (e.g., pocket-sized). They may include smart cards, ordinary credit or debit cards (with a magnetic strip and without a microprocessor), keychain devices (such as the Speedpass™ device commercially available from Exxon-Mobil Corp.), and so on. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

The payment processing system 126 may include data processing subsystems, networks, and operations used to support and deliver authorization services, exception file services, and clearing and settlement services. A typical payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) to process authorization requests and an accounting system to perform conventionally known clearing and settlement services.

The payment processing system 126 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing system 126 may use any suitable wired or wireless communication network, including the Internet. In an embodiment, the payment processing system 126 may include a transaction data warehouse 112, an application data store 114, a third party application data store 116, and a recommendation engine 118. These elements will be explained in further detail below.

Returning to the merchant 122, the merchant may have an access device 134 that can interact with the portable consumer device 132. The access device 134 according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device 134 is a point of sale terminal, any suitable point of sale terminal may be used including card readers. The card readers may include any suitable contact or contactless mode of operation. For example, typical card readers can include RF (radio frequency) antennas, magnetic stripe readers, etc. to interact with the portable consumer devices 132.

In a typical purchase transaction, the consumer 130 may purchase a good or service at the merchant 122 using a portable consumer device 132 such as a credit card. The consumer's portable consumer device 132 can interact with an access device 134 such as a POS (point of sale) terminal at the merchant 122. For example, the consumer 130 may take a credit card and may swipe it through an appropriate slot in the POS terminal. Alternatively, the POS terminal may be a contactless reader, and the portable consumer device 132 may be a contactless device such as a contactless card.

An authorization request message can then be created and forwarded to the acquirer 124. After receiving the authorization request message, the authorization request message can then be sent to the payment processing system 126. The payment processing system 126 can then forward the authorization request message to the issuer 128 of the portable consumer device 132.

After the issuer 128 receives the authorization request message, the issuer 128 may send an authorization response message back to the payment processing system 126 to indicate whether or not the current transaction is authorized (or not authorized). The transaction processing system 126 may then forward the authorization response message back to the acquirer 124. The acquirer 124 may then send the response message back to the merchant 122.

After the merchant 122 receives the authorization response message, the access device 134 at the merchant's premises may then provide an authorization response message which can be displayed by the access device, or may be printed out on a receipt. The transaction may then conclude with successful purchase, or the transaction may be denied.

At the end of the day, a conventionally known clearing and settlement process can be conducted by the transaction processing system 126. A clearing process is a process of exchanging financial details between and acquirer 124 and an issuer 128 to facilitate posting to a consumer's account and reconciliation of the consumer's settlement position.

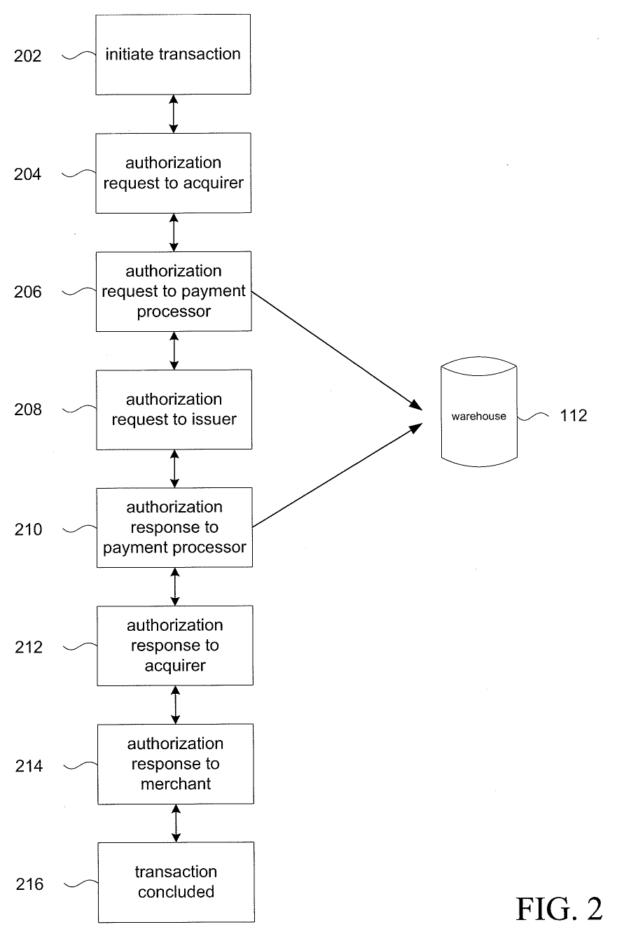

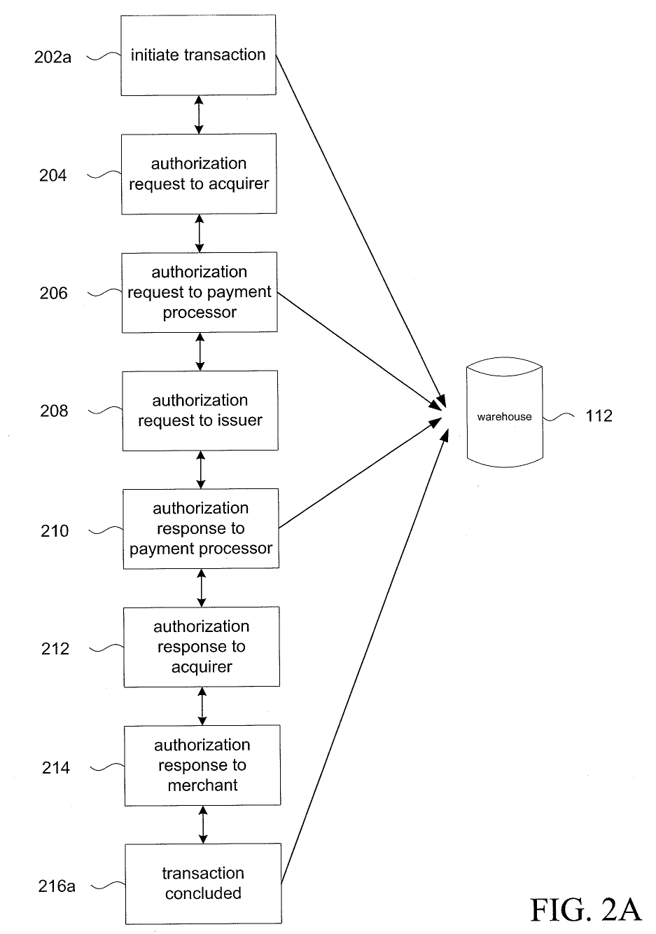

Refer now to FIGS. 1 and 2 for a discussion of a process flow in accordance with the present invention. As explained above, when the consumer 130 initiates a purchase transaction (step 202), the merchant 122 may initiate an authorization request sequence in order to authorize the transaction. Thus, in a step 204, an authorization request can be created and sent to the merchant's acquiring bank 124 (step 204); e.g., by swiping the consumer's credit card. The authorization request can be forwarded by the acquiring bank 124 to the payment processing system 126 (step 206).

The message payload in an authorization request conventionally includes information about the purchase transaction. Such information may include among other things: merchant information such as a merchant category code (MCC), a merchant terminal identifier, a SKU (stock keeping unit) code or other information that identifies the good/service being purchased, the purchase price, the date, and so on.

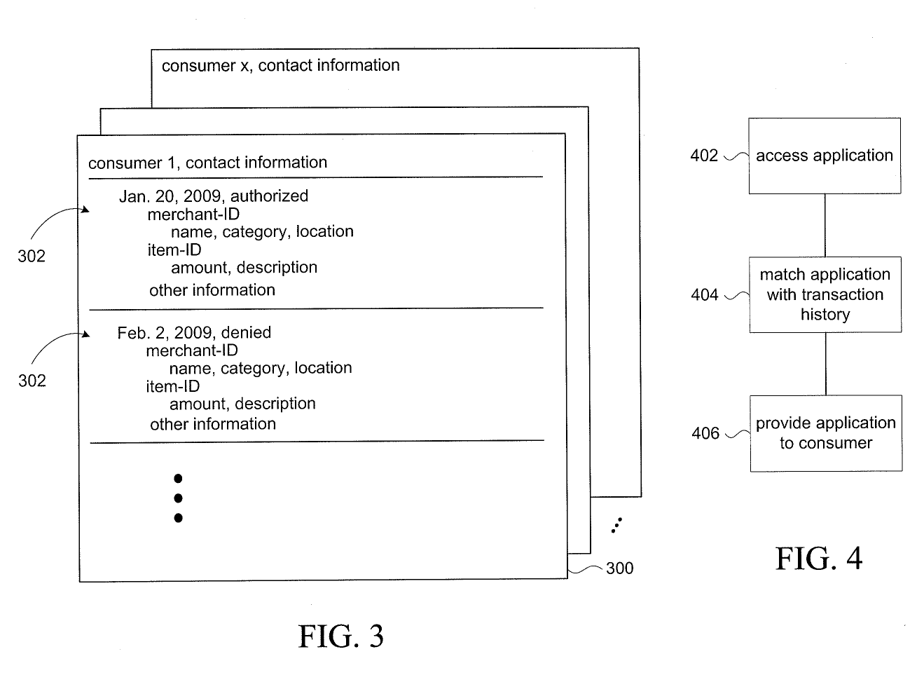

In an embodiment, the payment processing system 126 may store such information in the transaction data warehouse 112, for each transaction. FIG. 3 illustrates the data that can be retained in the transaction data warehouse 112. Thus, for each consumer 130, a set of data records 302 may be stored in the transaction data warehouse 112 for every transaction attempted by the consumer. The data records 302 for each consumer may include information such as date of purchase, a merchant identifier, name and location of the merchant, an identifier that indicates the item/service of the purchase, purchase amount and descriptive information of the item/service, and other suitable information (examples of which will be given below). Each data record 302 may include an indication whether the transaction was authorized or not.

Accordingly, the payment processing system 126 at step 206 can store in the transaction data warehouse 112 all or parts of the purchase transaction information that it receives. In this way, a purchase transaction history 300 can be collected and compiled for each consumer. It is recognized that the collection of such historical information may have to be authorized by the consumer for whom the information is being collected, depending on relevant privacy laws established by the government and any privacy policies of the payment processing system 112.

It will be appreciated that the particular structure of the data record 302, will depend largely on how the information being stored would be accessed and used and is therefore not germane to the present invention. For example, the “other information” data can be free form text, or it can be a structured organization of data. The particular data structures are a matter of implementation detail for a given embodiment.

Processing of the authorization request can continue whereby the payment processing system 126 forwards the authorization request to the issuing bank 128 (step 208). A determination to deny or approve the authorization request can then be made by the issuing bank 128. A suitable authorization response may be sent to the payment processing system 126. Information contained in the message payload of the authorization response that is relevant to purchase transaction history can be stored in the transaction data warehouse 112 and incorporated into the purchase transaction history 300 associated with that consumer.

Completing the discussion of FIG. 2, the authorization response can be passed back up to the merchant 122 via the acquiring bank 124 (steps 210, 212, and 214). The merchant may then conclude the purchase transaction with the consumer 130 (step 216). This may include denying the transaction if the authorization is denied by the issuing bank 128, or successfully completing the transaction if the authorization is approved by the issuing bank.

Referring for a moment to FIGS. 1A-1C and 2A, additional embodiments are discussed to illustrate alternative communication channels that can be used to populate the transaction data warehouse 112. For example in FIG. 1A, an embodiment is illustrated showing that a communication channel 152 may be provided between the merchant 122 and the payment processing center 126. A suitable communication protocol can be defined for exchanging information between the merchant 122 and the transaction data warehouse 112. The communication channel can be any suitable data channel; for example, the channel may be a virtual private network (VPN) defined over an existing communication channel.

FIG. 2A shows the processing that may be conducted in accordance with the embodiment illustrated in FIG. 1A. Thus, at step 202a, the merchant 122 may communicate information about the purchase directly to the payment processing center 126 as part of the purchase transaction with the consumer 130. This direct channel between the merchant 122 and the payment processing center 126 can allow the merchant to provide more information about the purchase than can be accommodated in the message payload of a conventional authorization request message. Such information can be stored in the data record 302 under the category “other information.” In embodiments, it may be desirable that the channel 152 be a secured channel in order to ensure privacy of communications between the merchant 122 and the payment processing center 126.

Processing of the authorization request in FIG. 2A may proceed in similar as shown in FIG. 2. At steps 206 and 210, the payment processing center 126 may also store information about the transaction, in addition to the information provided via the channel 152 by the merchant 122. At step 216a, the merchant 122 may provide further information about the transaction at the conclusion of the transaction. The merchant 122 can inform the transaction data warehouse 112 of the authorization result of the purchase request. The consumer 130 may be queried to provide information relating to the purchase.

Suppose, for example, the consumer 130 purchased a book of Italian recipes. The merchant 122 might query the consumer about their cooking interests, or interest in other cuisines, and so on. Such information may then be communicated to the payment processing center 126 and stored in the transaction data warehouse 112. Such “other information” may be stored in the data record 302 and associated with that consumer's purchase.

In FIG. 1B, an embodiment is illustrated showing that a communication channel 154 may be provided between the merchant 122 and the transaction data warehouse 112 itself (as compared to FIG. 1A where the communication channel 152 is with the payment processing system 126), whereby the merchant can directly store information about the transaction in the transaction data warehouse. A suitable communication protocol can be defined for exchanging information between the merchant 122 and the transaction data warehouse 112. Processing of a transaction may proceed according to FIG. 2A, where the merchant 122 communicates with transaction data warehouse 112 instead of the payment processing center 126.

In FIG. 1C, an embodiment is illustrated showing that a communication channel 156 may be provided between the consumer 130 (e.g., their mobile communication device 136a) and the transaction data warehouse 112. In an embodiment, the communication channel may be over the Internet and may use a secured channel such as SSL (secured sockets layer). For example, in an embodiment, the mobile device 136a may be used to make the purchase of an item. The item may include an RFID (radio frequency ID) tag. The mobile device 136a can be equipped with an RFID tag reader, which can read information from the tag on the item. Such information can then be sent to the transaction data warehouse 112 and associated with the consumer's data record 302 corresponding to the transaction.

In accordance with the embodiment shown in FIG. 1C, the processing in FIG. 2A may call for the mobile device to communicate information about the item being purchased to the transaction data warehouse 112, at step 202a. In step 214a, the consumer 130 may be queried for additional information, which can then be transmitted via the mobile device 136a to the transaction data warehouse 112.

In embodiments of the present invention, one or more computer software applications 142 can be provided to the consumer. For example, the computer software applications 142 can be delivered to their various mobile devices 136a, 136b such as cell phones, PDAs and so on. In embodiments, the computer software applications 142 may be delivered to any computing device, such a laptop computers, desktop computers, and so on. In embodiments, the computer software applications 142 may comprise executable program code that can be executed on a consumer's device. In accordance with the present invention, the computer software applications 142 can be value-added applications that might be of interest to the consumer. Examples of computer software applications 142 are discussed below.

In embodiments of the present invention, an application data store 114 (FIG. 1) and/or a third party application data store 116 can be provided to store a variety of such computer software applications. The data store 114 merely represents a store of computer software applications 142 developed by the payment processor system 126. Similarly, the data store 116 simply represents a store of computer software applications 142 developed by merchants 122 or a third party organization other than the payment processing system 126. In an embodiment, the data stores 114 and 116 may constitute a single data store implemented on a single storage subsystem. In an embodiment, the data stores 114 and 116 may be separate data stores provided on separate storage systems.

Computer software applications 142 may comprise any suitable code that can be executed by the consumer's mobile device 136a, 136b. In embodiments, a computer software application 142 may be computer executable instructions that are executed by a computer processor comprising the mobile device 136a, 136b. In embodiments, a computer software application 142 may comprise interpreted instructions such as Java® bytecode.

In an embodiment, the payment processing system 126 can provide for the delivery of computer software applications 142 to the consumer's mobile devices 136a, 136b or other suitable computing device. FIG. 4 describes an embodiment whereby a recommendation engine 118 can identify and deliver computer software applications 142 to the consumer 130. In accordance with the present invention, computer software applications 142 can be selected for a consumer 130 based at least on that consumer's purchase transaction history 300 and then delivered to the consumer's computing device(s), 132a, 136b.

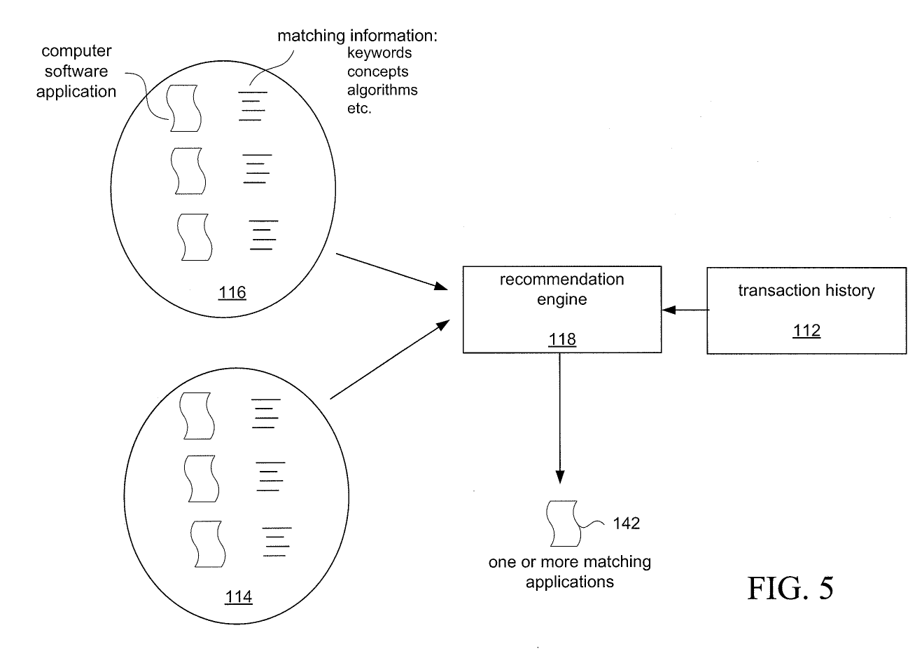

Referring to FIGS. 3-5, in a step 402, the recommendation engine 118 may access the application data stores 114, 116, and access a computer software applications 142 as a candidate for being downloaded or pushed to a consumer 130. In a step 404, the recommendation engine 118 may access the transaction data warehouse 112 to obtain a history 300 for a consumer 130. The data records 302 in the history 300 can be matched against the matching information (FIG. 5) corresponding to the candidate a computer software application. If the recommendation engine 118 determines that there is a match, then the candidate computer software application can be downloaded or pushed to the consumer (step 406), or alternatively, the candidate computer software application and can be marked or otherwise indicated for subsequent downloading to the consumer. The steps 404 and 406 can be repeated for each consumer 130 who has a purchase transaction history record 300 in the transaction data warehouse 112. Additional details of the matching (step 404) will be discussed below.

For those computer software applications 142 which match some aspect of the purchase transaction history 300 of a consumer, such identified computer software applications can be sent to the consumer 130, step 406. In an embodiment, the purchase transaction history 300 may include contact information for the consumer 130. Such contact information may include one or more email addresses, cell phone numbers, and so on. The recommendation engine 118 may select suitable contact information and initiate sending of the identified applications to the consumer 142, which will be discussed in further detail below.

In an embodiment, the matching information that is associated with each computer software application may comprise one or more “tags”; e.g., keywords, phrases, concepts, targeting criteria, and the like. In an embodiment, the provider of the computer software application 142 may provide a list of keywords that are then stored together in the application data store 114, 116. For example, suppose a computer software application 142 is developed by an organization that promotes the sport of archery; the computer software application might be a tutorial to teach safety in archery. The matching information that is associated with such an application can be specified by the archery organization and may include keywords such as “archery”, “bow and arrow”, and “beginners.” The application and keywords can be stored in the application data 116.

Suppose the purchase transaction history 300 for a consumer included a data record 302 for the purchase of a book entitled “Archery for Beginners.” The matching step 404 performed by the recommendation engine 118 may include a pattern matching operation that compares the keywords “archery”, “bow and arrow”, and “beginners” against the information in the data record. The pattern matching operation may result in a positive match if the keywords “archery” and “beginners” are matched against the title of the book. The recommendation engine 118 may then proceed to send the computer software application to the consumer (step 406).

In an embodiment, the tags that comprise the matching information can relate to dates, spending amounts, current balance, and so on. Tags can comprise logical expressions of such information to define criteria for matching the computer software application to a consumer. The recommendation engine 118 may be configured to process such matching information. For example, consider a computer software application that assists the consumer in managing their credit card spending. The payment processing system 126 might consider such an application to be a value-added service for certain of its consumers. The matching information associated with such an application might be a criterion like “balance >10,000”. In an embodiment, the recommendation engine 118 may evaluate the criterion using a consumer's balance (obtained from their purchase transaction history 300). If a match occurred, then the computer software application could be provided to the consumer.

In an embodiment, the tag comprising the matching information may include derived data. For example, a tag might look like “total_weekly_purchase >1000” where total_weekly_purchase can be derived data that is computed and maintained for each consumer. Any such derived information can be provided as part of the consumer's purchase transaction history 300. In an embodiment, the recommendation engine 118 can be configured to use the above logical expression as its matching information to provide a computer software application 142 to a consumer 130.

In an embodiment, the recommendation engine 118 may use fuzzy logic or other inference logic to identify candidate computer software applications. The recommendation engine 118 may use language matching algorithms. Such algorithms may be useful since exact matching is not always possible. In the archery example mentioned above, for example, if the book is entitled “Learning Archery”, then a strict keyword matching approach probably would not match any of the keywords “archery”, “bow and arrow”, and “beginners.” However, some appropriate inference logic or language processing logic might have a better chance of finding a match between the book title “Learning Archery” with the keywords “archery”, “bow and arrow”, and “beginners.” An illustrative, though by no means exhaustive, list of known algorithms includes: Soundex/Phonex to match similar sounding words; Porter or other stemming algorithms to perform matches based on particular word roots; Damerau-Levenshtein to detect similarity in strings; minimax for providing a series of best match options, which can include alpha-beta pruning to limit the options.

In an embodiment, the tags associated with computer software applications might comprise concepts. For example, the phrase “beginning archery” can be treated as a concept rather than keywords that are matched to data contained in the consumer's history 300. In an embodiment, the recommendation engine 118 may use appropriate logic to process tags as concepts. Thus, in the example above, the logic can produce a match between the concept of “beginning archery” with the title of the book “Learning Archery”.

In an embodiment, the matching information that is associated with each computer software application 142 may be an algorithmic procedure (a matching algorithm) that can be executed by the recommendation engine 118. For example, the matching algorithm can be a program written in a commonly known interpreted language, such as PERL; the procedures are referred to as PERL scripts. Of course other interpreted languages can be used. In embodiments, the algorithmic procedure can be compiled program, written in the C programming language for example. In embodiments, the provider of an computer software application 142 can design its own matching algorithm and provide it to the application data store 114 or 116.

In such embodiments, the matching step 404 performed by the recommendation engine 118 may include executing the matching algorithm. The matching algorithm can then cause the recommendation engine 118 to access the purchase history 300 for the consumer and perform an analysis of the information stored in the transaction data warehouse 112 to determine it the consumer would be a suitable candidate for receiving the computer software application associated with the given matching algorithm.

For example, suppose a computer software application 142 provides information about travel opportunities. The computer software application 142 might be written to access the web site of one or more travel agencies, e.g., via the internet, to pull down offers for vacations and present them on the device on which such application is executing. The sponsor or provider of such computer software application might be one or more of the travel agencies. The computer software application would have been developed and uploaded to the application data store 114, for example. A suitable matching algorithm can be associated with the computer software application. The matching algorithm can be designed to search the transaction data warehouse 112 to identify consumers who have purchased travel books; i.e., analyze the history 300 for each consumer. The matching algorithm may further analyze the history 300 for travel books specific to locations that the travel agencies offer vacations for. When the recommendation engine 118 executes this matching algorithm and identifies a matching consumer (step 404), such consumer can then be provided with the computer software application (step 406).

As another example, suppose a computer software application 142 is an interactive guide for repairing motorcycles. An organization such as a motorcycle owners association might want to be able to distribute such an application to suitable consumers 130. The motorcycle owners association can develop the interactive computer software application. The motorcycle owners association could also design the matching algorithm that would be associated with the computer software application. The matching algorithm can be designed to search the transaction data warehouse 112 for any consumer who has purchased a combination of motorcycle parts that might suggest they are about to embark on a repair project. In this situation, the matching algorithm can perform a more sophisticated analysis than could be possible by simply matching keywords.

In an embodiment, the matching information (FIG. 5) that is associated with each computer software application can comprise tags and a matching algorithm. The tags might serve as a first level filter to quickly eliminate a consumer. A consumer whose history 300 matches the tags, might then be subjected to closer scrutiny by executing the matching algorithm. Thus, for example, the recommendation engine 118 might conduct a matching operation (step 404) for a potential consumer by comparing the tags associated with a candidate computer software application against the history 300 of that potential consumer. If a match is not found, then the next consumer may be considered. If a match is found, then the recommendation engine 118 can execute the matching algorithm associated with the candidate computer software application to perform a deeper analysis of the potential consumer's history 300.

Returning to FIG. 4, any computer software applications 142 that is identified in the matching step 404 can then be sent to the consumer 130. In an embodiment, the identified computer software application(s) can be “pushed” to the consumer's device, which may require prior permission from the consumer. In an embodiment, the application can be segmented and pushed in a series of SMS messages and then reconstructed on the receiving device. In an embodiment, the consumer may be informed that one or more computer software applications are available. For example, the consumer 130 may receive a text message informing them of the availability of one or more computer software applications that are available for downloading. The text message could include a link. The consumer 130 could receive such a notification in an email, and so on. The consumer 130 can then send a suitable acknowledgement indicating that they accept the computer software application that is being offered.

In embodiments, the processing illustrated in FIG. 4 can be performed on a per transaction basis. In such embodiments of the present invention, an individual transaction can be used instead of the entire purchase transaction history 300 associated with that consumer. Such embodiments of the present invention can be used with consumers for whom no purchase transaction history has been accumulated. Thus, when a consumer 130 conducts an individual purchase transaction, the processing illustrated in FIG. 4 can be invoked in response to the individual purchase. The matching information associated with a candidate computer software application (selected in step 402) can be applied to the individual purchase transaction. Thus, in step 404 the “transaction history” can be the information related to the individual purchase transaction to which the matching information is applied. Steps 402 and 404 can be iterated for each computer software application 142 stored in the application stores 114, 116. Step 406 can then be performed to send any matched computer software applications to the consumer 130.

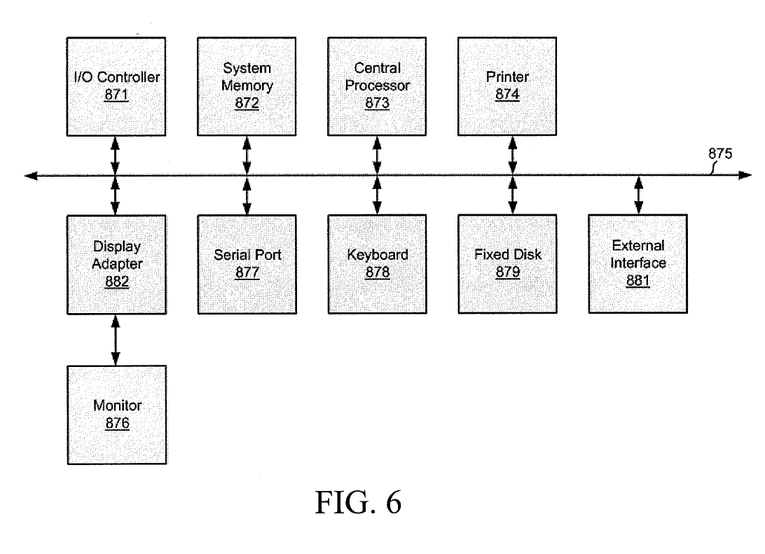

Any of the entities or components described above may include one or more of the subsystems or components shown in FIG. 6, which is a block diagram of a computer apparatus. The subsystems shown in the figure are interconnected via a system bus 875. Additional subsystems such as a printer 874, keyboard 878, fixed disk 879, monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 or external interface 881 can be used to connect the computer apparatus to a wide area network such as the Internet, a mouse input device, or a scanner. The interconnection via system bus allows the central processor 873 to communicate with each subsystem and to control the execution of instructions from system memory 872 or the fixed disk 879, as well as the exchange of information between subsystems. The system memory 872 and/or the fixed disk 879 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

In embodiments of the present invention, the purchase history of a consumer (e.g., purchase behavior and patterns) can be determined based on purchase transaction information generated from the consumer's purchases. The information can be used to further enhance relationships among consumers, merchants, and financial institutions such as the issuer. Merchants and financial institutions may benefit from tailored one-to-one relationships with their customers to foster enhanced cardholder retention and usage. With the appropriate customer permissions the payment processor, a financial institution, or an affinity partner can create tailored loyalty applications that may be delivered to a customer's phone, PC, or other IP connected electronic device to stimulate dialogue intended to enhance consumer.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method of delivering computer applications to a consumer comprising:
storing consumer purchase history information comprising purchase information relating to purchases made by consumers;
storing a plurality of applications, each application comprising computer executable program code, each application being associated with matching information;
a computer identifying a first application from among the plurality of applications for a first consumer using matching information associated with the first application; and
the computer sending the first application to a computing device of the first consumer, wherein the first application is executable on the computing device.

2. The method of claim 1 wherein the identifying further includes using consumer purchase history information associate with at least the first consumer.

3. The method of claim 1 wherein the identifying further includes using consumer purchase history information that is only associated with the first consumer.

4. The method of claim 1 wherein the identifying further includes using information relating to a purchase transaction conducted by the first consumer.

5. The method of claim 1 wherein the matching information comprises one or more of keywords, concepts, or criteria.

6. The method of claim 1 wherein the matching information comprises executable program code.

7. The method of claim 1 wherein the step of sending includes transmitting a notification to the first consumer and receiving an acknowledgement from the first consumer to send the first application.

8. The method of claim 1 further comprising receiving the purchase information in an authorization request associated with a purchase transaction.

9. The method of claim 1 further comprising receiving the purchase information from the merchant.

10. The method of claim 1 further comprising receiving the purchase information from the consumer.

11. The method of claim 1 wherein the first application comprises computer executable program code.

12. A method of providing a computer software application to a mobile communication device comprising:
a server computer system accumulating purchase transaction information relating to a consumer, the purchase transaction information indicative of a plurality of consumer purchases, the purchase transaction information including at least merchant information indicative of a merchant involved in said each consumer purchase and purchased item information indicative of one or more items involved in said each consumer purchase;
the server computer system storing a plurality of computer software applications in a data store;
the server computer system identifying a first computer software application from among the plurality of computer software applications and a first consumer based on the purchase transaction information; and
the server computer system communicating with a communication device of the first consumer to transmit the first computer software application thereto, the first computer software application being executable on the communication device.

13. The method of claim 12 wherein each of the computer software applications is associated with matching information, wherein identifying the first computer software application is based on associated matching information and the purchase transaction information.

14. The method of claim 12 wherein the matching information comprises one or more of keywords, concepts, or criteria.

15. The method of claim 12 wherein the matching information comprises executable program code.

16. The method of claim 12 wherein communicating includes transmitting a notification to the first consumer and receiving an acknowledgement from the first consumer to send the first computer software application.

17. The method of claim 12 wherein the matching information is compared only with consumer purchase history information that is associated with the first consumer.

18. A system comprising:
a computer system;
a first data storage system having stored thereon consumer purchase history information comprising purchase information relating to purchases made by consumers; and
a second data storage system having stored thereon a plurality of applications, each application comprising computer executable program code, each application being associated with matching information;
the computer system comprising computer program code configured to cause the computer system to perform steps of:
identifying a first application from among the plurality of applications;
identifying a first consumer from among the consumers; and
sending the first application to a computing device of the first consumer,
wherein identifying the first application and identifying the first consumer are based on information associated with the first application and the consumer purchase history information of the first consumer,
wherein the first application is executable on the computing device of the first consumer.

19. The system of claim 18 wherein the matching information comprises one or more of keywords, concepts, or criteria.

20. The system of claim 18 wherein the matching information comprises executable program code.
